(19) United States
(12) Patent Application Publication
(10) Pub. No.: US 2021/0247213 A1
(43) Pub. Date: Aug. 12, 2021

(54) MULTI-CHANNEL QUADRATURE SIGNALING WITH CURRENT MODE INTERFACE

(71) Applicant: Allegro MicroSystems, LLC, Manchester, NH (US)

(72) Inventors: Ryan J. Metivier, Merrimack, NH (US); Pablo Javier Bolsinger, Buenos Aires (AR)

(73) Assignee: Allegro MicroSystems, LLC, Manchester, NH (US)

(21) Appl. No.: 16/787,326

(22) Filed: Feb. 11, 2020

(51) Int. Cl. G01D 5/244; G01D 5/245

(52) U.S. Cl. CPC G01D 5/24466; G01D 5/245

(57) ABSTRACT

A magnetic field sensor includes one or more magnetic field sensing elements operable to generate a respective one or more magnetic field signals indicative of a magnetic field associated with an object, and one or more channel detector circuits coupled to receive one or more of the one or more magnetic field signals. The one or more channel detector circuits are configured to generate a respective one or more channel signals. The sensor also includes an output protocol circuit coupled to receive the one or more channel signals. The output protocol circuit is configured to generate a sensor output signal comprising distinguishable constant current levels associated with the one or more channel signals.

### FIELD

This disclosure relates generally to sensors, and more particularly, to output signal protocols for magnetic field sensors with current mode interfaces.

### BACKGROUND

As is known in the art, sensors are used in various types of devices to measure and monitor properties of systems in a wide variety of applications. For example, sensors have become common in products that rely on electronics in their operation, such as automobile control systems. Examples of automotive applications are the detection of ignition timing from an engine crankshaft and/or camshaft, the detection of wheel speed for anti-lock braking systems and four-wheel steering systems, and the speed and direction of transmission gears.

Some sensors monitor properties by detecting a magnetic field associated with proximity or movement of a target object with respect to one or more magnetic field sensing elements. In magnetic field sensors including multiple magnetic field sensing elements, magnetic field signals from the sensing elements can be processed by separate processing channels to generate respective phase separated signals. One such magnetic field sensor is the Allegro MicroSystems, LLC ATS605LSG Dual Output Differential Speed and Direction Sensor IC, in which the output signals from each of the processing channels are provided at respective output pins of the sensor integrated circuit (IC). In an automotive application, the sensor IC output signals can be coupled to an engine control unit (ECU) for further processing, such as detection of gear or wheel speed, direction and/or vibration.

### SUMMARY

This Summary is provided to introduce a selection of concepts in simplified form that are further described below in the Detailed Description. This Summary is not intended to identify key or essential features or combinations of the claimed subject matter, nor is it intended to be used to limit the scope of the claimed subject matter.

The concepts described herein are directed toward provide a magnetic field sensor (e.g., rotation detector) that includes a current interface to provide information regarding a moving or rotating ferromagnetic object. Some embodiments can provide speed and direction information in an output signal of the magnetic field sensor. Some embodiments provide information indicative of a power on state of the magnetic field sensor. Some embodiments provide information indicative of a failure state of the magnetic field sensor.

In accordance with an embodiment, a magnetic field sensor includes one or more magnetic field sensing elements operable to generate a respective one or more magnetic field signals indicative of a magnetic field associated with an object, and one or more channels coupled to receive one or more of the one or more magnetic field signals. The one or more channels are configured to generate a respective one or more channel signals. The sensor also includes an output protocol circuit coupled to receive the one or more channel signals. The output protocol circuit is configured to generate a sensor output signal comprising distinguishable constant current levels associated with the one or more channel signals.

In accordance with an embodiment, a method to indicate a state of a magnetic field sensor includes generating one or more magnetic field signals indicative of a magnetic field associated with an object and processing the one or more magnetic field signals to generate a respective one or more channel signals. The method also includes processing the respective one or more channel signals to generate a sensor output signal comprising distinguishable constant current levels associated with the one or more channel signals.

In accordance with an embodiment, a magnetic field sensor includes a means for generating magnetic field signals indicative of a magnetic field associated with an object and a means for generating phase separated channel signals based on the magnetic field signals. The magnetic field sensor also includes a means for generating a sensor output signal comprising distinguishable constant current levels associated with the channel signals.

### BRIEF DESCRIPTION OF THE DRAWINGS

The foregoing features of the disclosure, as well as the disclosure itself may be more fully understood from the following detailed description of the drawings. The drawings aid in explaining and understanding the disclosed technology. Since it is often impractical or impossible to illustrate and describe every possible embodiment, the provided figures depict one or more exemplary embodiments. Accordingly, the figures are not intended to limit the scope of the claimed subject matter. Like numbers in the figures denote like elements.

FIG. 1 is a block diagram illustrating selected components of an example magnetic field sensor including a current mode interface, in accordance with an embodiment of the present disclosure.

FIG. 2 illustrates a state table showing example output currents based on input channel signals, in accordance with an embodiment of the present disclosure.

FIG. 3 illustrates example waveforms, including magnetic field signals, phase separated channel signals, and a sensor output signal including constant output current levels associated with each of the phase separated channel signals that are distinguishable based on signal level, in accordance with an embodiment of the present disclosure.

FIG. 4 illustrates example waveforms, including magnetic field signals, phase separated channel signals, and a sensor output signal including constant output current levels associated with each of the phase separated channel signals that are distinguishable based on signal level, in accordance with an embodiment of the present disclosure.

FIG. 5A illustrates an example waveform of a channel signal and a diagnostic signal. FIG. 5B illustrates an example waveform of a sensor output signal indicating a fault state based on the signals of FIG. 5A, in accordance with an embodiment of the present disclosure.

FIG. 6A illustrates an example waveform of a channel signal and a diagnostic signal. FIG. 6B illustrates an example waveform of a sensor output signal indicating a fault state based on the signals of FIG. 6A, in accordance with an embodiment of the present disclosure.

### DETAILED DESCRIPTION

Embodiments of the present disclosure provide a magnetic field sensor (e.g., rotation detector) that includes a current interface to provide information regarding a moving or rotating ferromagnetic object. According to some embodiments, the current interface of the magnetic field sensor may communicate information indicative of the speed and direction of the rotation. In some embodiments, the interface may also communicate information indicative of normal operation and/or diagnostic condition of the magnetic field sensor. In some embodiments, the interface may also provide information indicative of a power on state of the magnetic field sensor. Numerous configurations, variations, and embodiments will be apparent in light of this disclosure.

Before describing the various embodiments of the concepts described herein, some introductory concepts and terminology are explained. As used herein, the term “rotation detector” is used to describe a circuit that includes at least one “magnetic field sensing element” which detects a magnetic field. The rotation detector can sense movement, e.g., rotation, of a ferromagnetic object, for example, advance and retreat of magnetic domains of a ring magnet or advance and retreat of gear teeth of a ferromagnetic gear. Similarly, the term “movement detector” can be used to describe either a rotation detector or a magnetic field sensor that can sense different movement, e.g., linear movement, of a ferromagnetic object, for example, linear movement of magnetic domains of a ring magnet or linear movement of gear teeth of a ferromagnetic gear.

As used herein, the term “magnetic field sensing element” is used to describe a variety of electronic elements that can sense a magnetic field. The magnetic field sensing element can be, but is not limited to, a Hall effect element, a magnetoresistance element, or a magnetotransistor. As is known, there are different types of Hall effect elements, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III-V semiconductor material like Gallium-Arsenide (GaAs) or an Indium compound, e.g., Indium-Antimonide (InSb).

As is known, some of the above-described magnetic field sensing elements tend to have an axis of maximum sensitivity parallel to a substrate that supports the magnetic field sensing element, and others of the above-described magnetic field sensing elements tend to have an axis of maximum sensitivity perpendicular to a substrate that supports the magnetic field sensing element. In particular, planar Hall elements tend to have axes of sensitivity perpendicular to a substrate, while metal based or metallic magnetoresistance elements (e.g., GMR, TMR, AMR) and vertical Hall elements tend to have axes of sensitivity parallel to a substrate.

As used herein, the term “magnetic field sensor” or simply “sensor” is used to describe a circuit that uses one or more magnetic field sensing elements, generally in combination with other circuits. The magnetic field sensor can be, for example, a rotation detector, a movement detector, a current sensor, or a proximity detector.

Magnetic field sensors are used in a variety of applications, including, but not limited to, an angle sensor that senses an angle of a direction of a magnetic field, a current sensor that senses a magnetic field generated by a current carried by a current-carrying conductor, a magnetic switch that senses the proximity of a ferromagnetic object, a rotation detector (or movement detector) that senses passing ferromagnetic articles, for example, magnetic domains of a ring magnet or a ferromagnetic target (e.g., gear teeth) where the magnetic field sensor is used in combination with a back-bias or other magnet, and a magnetic field sensor that senses a magnetic field density of a magnetic field.

As used herein, the term “processor” is used to describe an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some embodiments, the “processor” can be embodied in an application specific integrated circuit (ASIC), which can be an analog ASIC or a digital ASIC. In some embodiments, the “processor” can be embodied in a microprocessor with associated program memory. In some embodiments, the “processor” can be embodied in a discrete electronic circuit, which can be an analog or digital. A processor can contain internal processors or internal modules that perform portions of the function, operation, or sequence of operations of the processor. Similarly, a module can contain internal processors or internal modules that perform portions of the function, operation, or sequence of operations of the module.

While electronic circuits shown in figures herein may be shown in the form of analog blocks or digital blocks, it will be understood that the analog blocks can be replaced by digital blocks that perform the same or similar functions and the digital blocks can be replaced by analog blocks that perform the same or similar functions. Analog-to-digital or digital-to-analog conversions may not be explicitly shown in the figures, but should be understood.

It should be understood that a so-called “comparator” can be comprised of an analog comparator having a two-state output signal indicative of an input signal being above or below a threshold level (or indicative of one input signal being above or below another input signal). However the comparator can also be comprised of a digital circuit having an output signal with at least two states indicative of an input signal being above or below a threshold level (or indicative of one input signal being above or below another input signal), respectively, or a digital value above or below a digital threshold value (or another digital value), respectively.

As used herein, the term “predetermined,” when referring to a value or signal, is used to refer to a value or signal that is set, or fixed, in the factory at the time of manufacture, or by external means, e.g., programming, thereafter. As used herein, the term “determined,” when referring to a value or signal, is used to refer to a value or signal that is identified by a circuit during operation, after manufacture.

Signals with pulses are described herein as generated by a magnetic field sensor. In some embodiments, the signals are provided on a communication link to an external processor, for example, a CPU within an automobile, to further process the pulses. As used herein, the term “pulse” is used to describe a signal that begins at a first level or state, transitions rapidly to a second level or state different than the first level and returns rapidly to the first level.

Ferromagnetic objects described herein can have a variety of forms, including, but not limited to, a ring magnet having one or more pole pair, and a gear having two or more gear teeth. Ferromagnetic gears are used in some examples below to show a rotating ferromagnetic object having ferromagnetic features, i.e., teeth. However, in other embodiments, the gear can be replaced with a ring magnet having at least one pole pair. Also, linear arrangements of ferromagnetic objects are possible that move linearly.

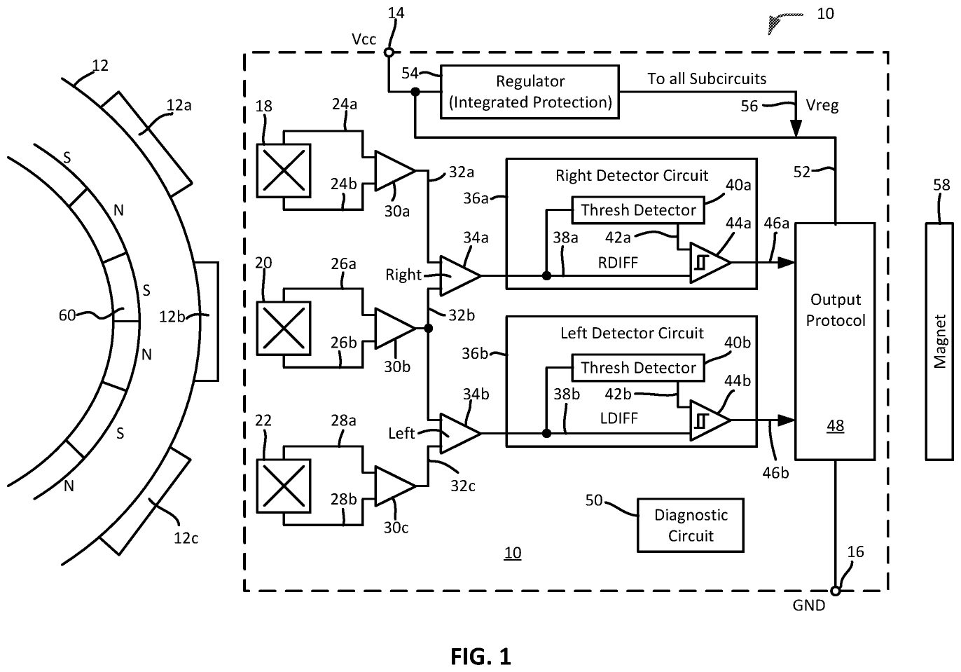

Referring to FIG. 1, an example magnetic field sensor 10, such as a rotation detector, having two channels can be used, for example, to detect passing gear teeth or a sections of a ring magnet, examples of which will be described below. It will be appreciated that as used herein the term “channel” refers generally to processing circuitry associated with one or more magnetic field sensing elements and configured to generate a channel signal. In the illustrative example of FIG. 1, an example magnetic field sensor 10, such as a rotation detector, having two channels can be used, for example, to detect passing gear teeth such as gear teeth 12a-12c of a ferromagnetic gear 12, for example. In such embodiments, a permanent magnet 58 can be placed at a variety of positions proximate to gear 12, resulting in fluctuations of a magnetic field proximate to gear 12 in response to movement (e.g., clockwise rotation) of gear teeth 12a-12c. Use of the above-described magnet results in a so-called “back-bias” arrangement.

In other embodiments, magnet 58 and gear 12 can be omitted. Instead, sensor 10 can be used to detect a rotation of a ring magnet 60 having at least one north pole and at least one south pole.

As can be seen, sensor 10 can have a first terminal 14 coupled to a power supply denoted as Vcc. Sensor 10 can also have a second terminal 16 coupled to a fixed voltage source, for example, a ground voltage source, denoted as GND. Thus, in some implementations, sensor 10 is a two-terminal device (or two wire device), for which an output signal may appear as a signal current at first terminal 14, superimposed upon the power supply voltage, Vcc. However, in other arrangements, one of ordinary skill in the art will understand that a sensor similar to sensor 10 can be a three terminal device (three wire device) that has a third terminal (not shown) at which an output signal can appear as a voltage rather than a current. In any case, sensor 10 can be provided in the form of an integrated circuit (IC), with terminals 14, 16 provided by pins or leads of the IC.

Sensor 10 can include first, second, and third magnetic field sensing elements 18, 20, 22, respectively, here shown to be Hall effect elements. The first Hall effect element 18 generates a first differential voltage signal 24a, 24b, the second Hall effect element 20 generates a second differential voltage signal 26a, 26b, and the third Hall effect element 22 generates a third differential voltage signal 28a, 28b, each having respective AC signal components in response to rotating gear 12.

While each one of the Hall effect elements 18, 20, 22 is shown in FIG. 1 to be a two terminal device, one of ordinary skill in the art will understand that each one of the Hall effect elements 18, 20, 22 is actually a four terminal device and the other two terminals of the Hall effect elements can be coupled to receive and pass respective currents as might be provided, for example, by a current source or by a voltage source (not shown).

As can be seen, first differential voltage signal 24a, 24b can be received by a first differential preamplifier 30a, second differential voltage signal 26a, 26b can be received by a second differential preamplifier 30b, and third differential voltage signal 28a, 28b can be received by a third differential preamplifier 30c.

First and second amplified signals 32a, 32b generated by first and second differential preamplifiers 30a, 30b, respectively, are received by a “right” channel amplifier 34a and second amplified signal 32b and a third amplified signal 32c generated by second and third differential preamplifiers 30b, 30c, respectively, are received by a “left” channel amplifier 34b. Note that the designations of “right” and “left” are arbitrary.

A signal 38a generated by right channel amplifier 34a is received by a right channel detector circuit 36a and a signal 38b generated by left channel amplifier 34b is received by a left channel detector circuit 36b. Signals 38a, 38b can be analog signals, generally sinusoidal in nature. Thus, sensor 10 can be considered to include a right processing channel (or simply right channel) including amplifier 34a and right detector circuit 36a and a left processing channel (or simply left channel) including amplifier 34b and detector circuit 36b.

It will be appreciated that a “channel” refers generally to processing circuitry associated with one or more magnetic field sensing elements and configured to generate a respective channel signal. While the particular processing circuitry shown in FIG. 1 to provide the right channel circuitry includes right channel amplifier 34a and right channel detector circuit 36a (and similarly the processing circuitry shown in FIG. 1 to provide the left channel circuitry includes left channel amplifier 34b and left channel detector circuit 36b), such channels can include less, more, or different processing circuitry.

Taking right channel detector circuit 36a as representative of both of detector circuits 36a, 36b, right channel detector circuit 36a includes a threshold detector circuit 40a coupled to receive the signal 38a. Threshold detector circuit 40a is configured to detect positive and negative peaks of signal 38a, to identify a peak-to-peak value of signal 38a, and to generate a threshold signal 42a that, for example, takes on a first threshold at forty percent of the peak-to-peak value of signal 38a and a second threshold value at sixty percent of the peak-to-peak value of signal 38a. However, forty percent and sixty percent are simply examples and the threshold values can vary, and the claimed invention is not intended to be limited to any particular thresholds. A comparator 44a is coupled to receive threshold signal 42a and is also coupled to receive signal 38a. As a result, comparator 44a generates a binary, two-state, signal 46a that has transitions when signal 38a crosses both the first and second thresholds.

A signal 46b generated by left channel detector circuit 36b is generated in the same way as described above with respect to signal 46a. However, since magnetic field sensing elements 18, 20 contribute to signal 46a, while magnetic field sensing elements 20, 22 contribute to signal 46b, it should be appreciated that signals 46a, 46b have edges that differ in time (which is equivalent to phase for a particular signal frequency, e.g., particular rotation speed). Stated another way, the channels are configured to generate respective phase separated channel signals 46a, 46b.

Still referring to FIG. 1, sensor 10 can include an output protocol module 48 coupled to receive and process signals 46a, 46b and configured to generate output signal 52. In some such embodiments, output protocol module 48 can provide output signal 52 in the form of a current (e.g., current signal). In some embodiments, the output current signal can be indicative of a speed and/or direction of rotation of a target, such as a gear 12. For example, a movement speed of gear 12 can be detected by output protocol module 48 in accordance with a frequency of signals 38a, 38b or 46a, 46b. A direction of movement of gear 12 can be detected in accordance with the sequence of the current levels resulting from combining the current levels of signals 46a, 46b. In some embodiments, the constant output current signal can be indicative of a power on state of sensor 10, such as the power on state of at least one channel of sensor 10, for example.

While sensor 10 is shown to include the two detector circuits 36a, 36b, each having a particular topology, it should be understood that any form of peak-referenced detectors (such as, for example, peak detectors) or peak-to-peak percentage detectors (such as, for example, threshold detectors), including, but not limited to, the above-described peak detectors and threshold percentage detectors, can be used in place of or in addition to detector circuits 36a, 36b.

In some embodiments, and as will be further described below, output protocol module 48 can be operable to generate output signal formats described in conjunction with the figures below.

In some embodiments, a diagnostic circuit 50 is configured to detect a failure or fault of sensor 10. In an example implementation, diagnostic circuit 50 can be configured to test one or more components, such as, for example, magnetic field sensing elements, differential preamplifiers, channel amplifier, detector circuits, of sensor 10. Upon detecting a failure or a fault, diagnostic circuit 50 can provide a fault indication or fault state to output protocol module 48. In such embodiments, the fault indication may be provided as a current signal to output protocol module 48 or any other appropriate component of sensor 10 at a signal level other than the levels used to convey normal operating information (e.g., a diagnostic or fault current).

In other embodiments, diagnostic circuit 50 can be provided external to sensor 10. For instance, in various embodiments, sensor 10 may not include diagnostic circuit 50, but sensor 10 may connect or otherwise couple to an externally provided diagnostic circuit 50 or other suitable diagnostic module via interface circuitry.

While the embodiments of FIG. 1 include three magnetic field sensing elements 18, 20, 22, coupled in the same manner to generate signals 38a, 38b (i.e., magnetic field signal 32a is combined with magnetic field signal 32b to generate differential signal 38a and magnetic field signal 32b is combined with magnetic field signal 32c to generate differential signal 38b, such that the center element 20 is “shared” by the two channels), it will be appreciated that other numbers and configurations of sensing element(s) and/or processing channels can be used. By way of non-limiting examples, channels can be based on (i.e., can process) signals from separate (i.e., not differentially combined) magnetic field sensing elements or some channels can be based on signals from separate magnetic field sensing elements and other channels can be based on differentially combined signals from a plurality of magnetic field sensing elements.

In some embodiments, right and left detector circuits 36a, 36b are omitted and signals 38a, 38b are converted to digital signals and communicated directly to output protocol module 48. As will be appreciated, numerous configurations can be implemented, and the present disclosure is not intended to be limited to any particular one.

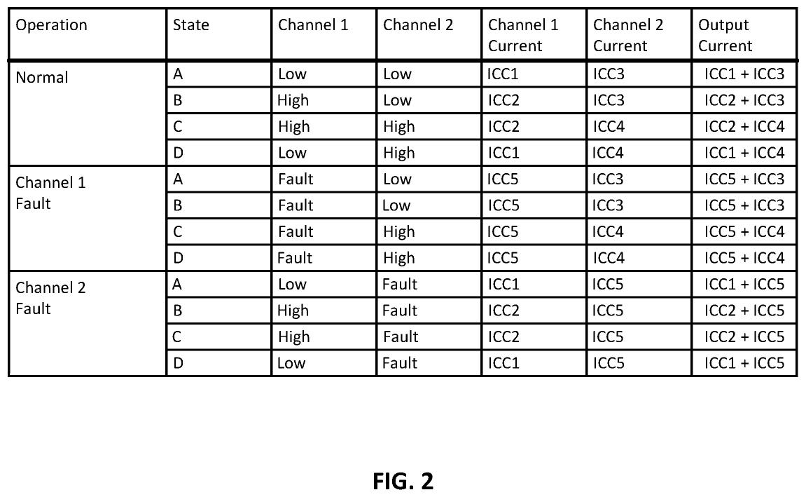

FIG. 2 illustrates a state table showing example output currents based on input channel signals, in accordance with an embodiment of the present disclosure. In brief, the illustrated state table defines the functioning of output protocol module 48 of FIG. 1. More particularly, the state table indicates the current levels of output signal 52 in accordance with an example implementation of output protocol module 48 of FIG. 1. In the state table, the Operation column indicates the operational states of the two channels, such as channel signal 46a output from right detector circuit 36a (also referred to herein as channel 1 signal 46a) and channel signal 46b output from left detector circuit 36b (also referred to herein as channel 2 signal 46b). Still referring to the state table, the State column indicates the state of the two channels, channel 1 and channel 2, the Channel 1 column indicates the state of channel 1, the Channel 2 column indicates the state of channel 2, the Channel 1 Current column indicates the current level of channel 1 signal 46a, the Channel 2 Current column indicates the current level of channel 2 signal 46b, and the Output Current column indicates the current level of output signal 52.

The operational states of the two channels include Normal, Channel 1 Fault, and Channel 2 Fault. In the Normal operational state, both channel 1 and channel 2 are in a normal operational state (i.e., non-fault state). In the Channel 1 Fault operational state, channel 1 is in a fault state and channel 2 is in a normal operational state. In the Channel 2 Fault operational state, channel 1 is in a normal operational state and channel 2 is in a fault state.

In the Normal operational state, the two channels, channel 1 and channel 2, can be in either state A, B, C, or D. In Normal operational state A, channel 1 is in a low current state where the current level of channel 1 signal 46a is ICC1, channel 2 is in a low current state where the current level of channel 2 signal 46a is ICC3, and the resulting output signal 52 has a current level that is the combination of the channel 1 and channel 2 current levels (ICC1+ICC3). In Normal operational state B, channel 1 is in a high current state where the current level of channel 1 signal 46a is ICC2, channel 2 is in a low current state where the current level of channel 2 signal 46a is ICC3, and the resulting output signal 52 has a current level that is the combination of the channel 1 and channel 2 current levels (“ICC2+ICC3”). In Normal operational state C, channel 1 is in a high current state where the current level of channel 1 signal 46a is ICC2, channel 2 is in a high current state where the current level of channel 2 signal 46a is ICC4, and the resulting output signal 52 has a current level that is the combination of the channel 1 and channel 2 current levels (ICC2+ICC4). In Normal operational state D, channel 1 is in a low current state where the current level of channel 1 signal 46a is ICC1, channel 2 is in a high current state where the current level of channel 2 signal 46a is ICC4, and the resulting output signal 52 has a current level that is the combination of the channel 1 and channel 2 current levels (ICC1+ICC4).

In the “Channel 1 Fault” operational state, the two channels, channel 1 and channel 2, can be in either state “A”, “B”, “C”, or “D”. In Channel 1 Fault operational states A and B, channel 1 is in a Fault state where the current level of channel 1 signal 46a is a diagnostic current ICC5, channel 2 is in a low current state where the current level of channel 2 signal 46a is ICC3, and the resulting output signal 52 has a current level that is the combination of the channel 1 and channel 2 current levels (ICC5+ICC3). In Channel 1 Fault operational states C and D, channel 1 is in a Fault state where the current level of channel 1 signal 46a is a diagnostic current ICC5, channel 2 is in a high current state where the current level of channel 2 signal 46a is ICC4, and the resulting output signal 52 has a current level that is the combination of the channel 1 and channel 2 current levels (ICC5+ICC4).

In the “Channel 2 Fault” operational state, the two channels, channel 1 and channel 2, can be in either state “A”, “B”, “C”, or “D”. In Channel 2 Fault operational states A and D, channel 1 is in a low current state where the current level of channel 1 signal 46a is ICC1, channel 2 is in a Fault state where the current level of channel 2 signal 46a is a diagnostic current ICC5, and the resulting output signal 52 has a current level that is the combination of the channel 1 and channel 2 current levels (ICC1+ICC5). In Channel 1 Fault operational states B and C, channel 1 is in a high current state where the current level of channel 1 signal 46a is ICC2, channel 2 is in a Fault state where the current level of channel 2 signal 46a is a diagnostic current ICC5, and the resulting output signal 52 has a current level that is the combination of the channel 1 and channel 2 current levels (ICC2+ICC5).

It will be appreciated that the diagnostic current levels can be the same or different for the two channels.

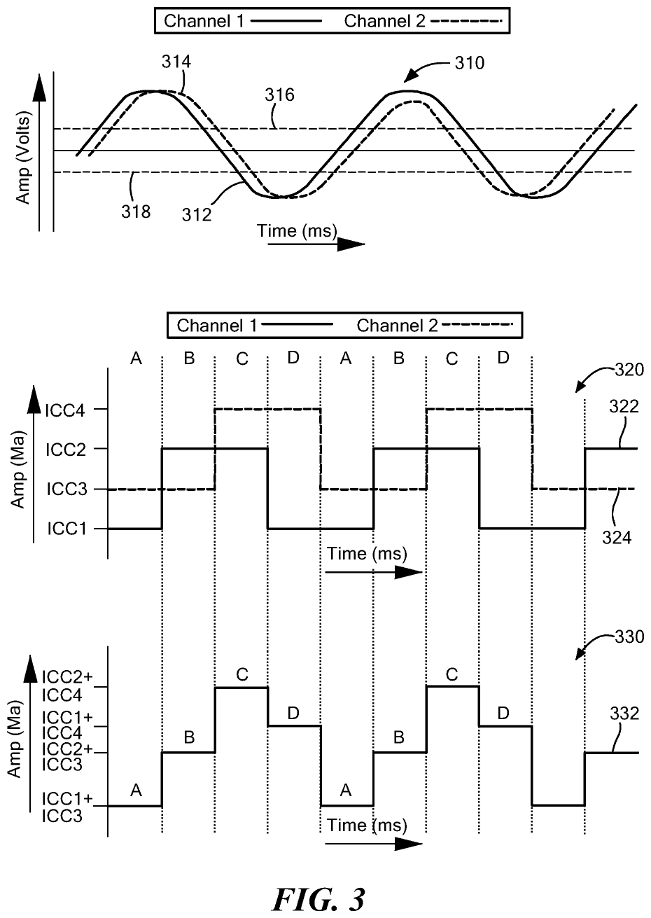

FIG. 3 illustrates example waveforms, including magnetic field signals, phase separated channel signals, and a sensor output signal including constant output current levels associated with each of the phase separated channel signals that are distinguishable based on signal level, in accordance with an embodiment of the present disclosure. As shown, graphs 310, 320, 330 have the same horizontal axes with scales in arbitrary units of time. The vertical axis of graph 310 is in a scale of units of volts and the vertical axis of graphs 320, 330 are in scales of units of amps. In graph 310, signals 312, 314 can be indicative of signals 38a, 38b of FIG. 1. A threshold 316 is indicative, for example, of sixty percent of a peak-to-peak value of either one of signals 312, 314, and a threshold 318 is indicative, for example, of forty percent of a peak-to-peak value of either one of the signals 312, 314. Thresholds 316, 318 can be generated, for example, by one of (or both of) threshold detectors 40a, 40b of FIG. 1. Two thresholds 316, 318 are shown for clarity. However, in some embodiments, each one of threshold detectors 40a, 40b can generate two respective thresholds, in which case, there can be four thresholds, two thresholds applied to signal 38a and the other two applied to other signal 38b of FIG. 1.

In graph 320, signals 322, 324 can be indicative of phase separated channel signals 46a, 46b of FIG. 1. In the illustrated example, signal 322 can be for a first channel (e.g., channel 1) and signal 324 can be for a second channel (e.g., channel 2). Signals 322, 324 can be two state signals having transitions when signals 312, 314 cross thresholds 316, 318. As can be seen, each signal 322, 324 can be comprised of a series of pulses that have positive and negative transitions (i.e., rising and falling edges). In particular, the pulses of signals 322, 324 can be separated by about 90 degrees, as shown.

Still referring to graph 320, signals 322, 324 can have discrete current levels. More particularly, as two state signals, signal 322 can have two discrete current levels, and signal 324 can have two discrete current levels, which are each different than the two discrete current levels of signal 324. Thus, signals 322, 324 have four discrete signal levels. As the pulses of signals 322, 324 are phase-separated, the combination of the four discrete current levels of signals 322, 324 can be indicative of four discrete states, such as, for example, the four states of Normal operation, A, B, C, and D, described above with respect to FIG. 2.

As will be appreciated in light of this disclosure, a direction of rotation of the target can be determined by the sequence of the four states produced or otherwise generated by the combination of signals 322, 324. The sequence of the four states is based upon which channel signal leads and which channel signal lags. For example, signal 322 leading signal 324 can produce a first sequence of the four states that indicates a first direction of target rotation and signal 322 lagging signal 324 can produce a second sequence of the four states that indicates a second direction of target rotation. Thus, channel signals 322, 324 can be processed to determine a direction of rotation of the target.

As will also be appreciated in light of this disclosure, a rate or frequency of the pulses of signal 322 can be indicative of a speed of rotation of the target. Likewise, a rate of the pulses of signal 324 can be indicative of the speed of rotation of the target. In this way, channel signals 322, 324 can be considered to contain redundant target speed information. Therefore, the speed of rotation of the target can be determined from either one of signals 322, 324. Thus, either one of channel signals 46a, 46b can fault and signal 322 or signal 324 corresponding to the non-faulting channel signal can be used to determine the speed of rotation of the target.

In graph 330, a signal 332 can be an example of a serial signal that can be the same or similar to output signal 52 of FIG. 1. In the illustrated example, signal 332 is a signal that can include constant output current levels. As can be seen, signal 332 includes four distinguishable constant output current levels. The distinguishable constant current levels are associated with the channel signals. More particularly, the four different current levels can be indicative of the combination of the current levels of signals 322, 324. More particularly, a first current level can be indicative of a first state (e.g., Normal operational state A) of the current levels of signals 322, 324, a second current level can be indicative of a second state (e.g., Normal operational state B) of the current levels of signals 322, 324, a third current level can be indicative of a third state (e.g., Normal operational state C) of the current levels of signals 322, 324, and a fourth current level can be indicative of a fourth state (e.g., Normal operational state D) of the current levels of signals 322, 324. The sequence of the current levels of signal 332 can be indicative a direction of rotation of the target. For example, as can be seen, the sequence of current levels A, B, C, D is produced by the leading edges of the pulses of signal 322 leading the leading edges of the pulses of signal 324. This may indicate the first direction of target rotation as described above. In addition, a rate of change or transition of the current levels (signal levels) of signal 332 can be indicative of a speed of rotation of the target.

As will be appreciated by those of ordinary skill in the art after reading this disclosure, the constant output current levels of signal 332 allows for determining a power on state of a sensor, such as sensor 10 of FIG. 1. That is, the constant output current levels of signal 332 can be indicative of a state of the two channels (e.g., channel 1 as indicated by signal 322 and channel 2 as indicated by signal 324) of sensor 10 at any time including at a time proximate to power on of sensor 10.

It will be appreciated that various circuitry and techniques are possible for implementing output protocol module 48 (FIG. 1) to provide signal 332. In an embodiment, output protocol module 48 generates signal 332 by combining the separate pulse train signals of the two channels, such as the separate pulse trains of signals 46a, 46b with a logical AND operator.

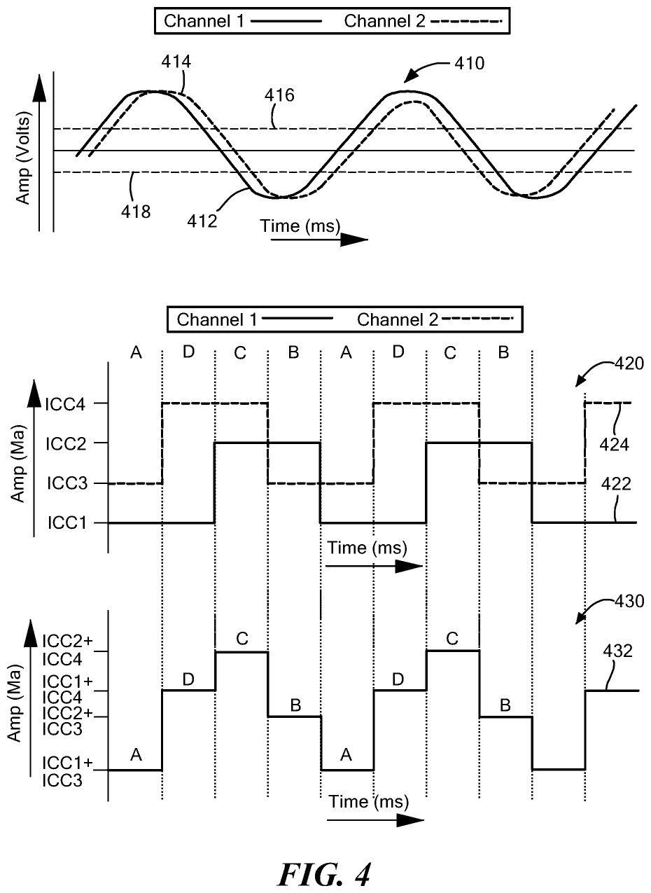

FIG. 4 illustrates example waveforms, including magnetic field signals, phase separated channel signals, and a sensor output signal including constant output current levels associated with each of the phase separated channel signals that are distinguishable based on signal level, in accordance with an embodiment of the present disclosure. As shown, graphs 410, 420, 430 have the same horizontal axes with scales in arbitrary units of time. The vertical axis of graph 410 is in a scale of units of volts and the vertical axis of graphs 420, 430 are in scales of units of amps. Graphs 410, 420 are substantially similar to graphs 310, 320 illustrated in FIG. 3. Thus, the previous relevant discussion with respect to features of graphs 310, 320 of FIG. 3 that are similar to graphs 410, 420 is equally applicable here. For example, similar to signals 312, 314 of graph 310 and signals 322, 324 of graph 320, signals 412, 414 of graph 410 can be indicative of signals 38a, 38b of FIG. 1, and signals 422, 424 of graph 420 can be indicative of phase separated channel signals 46a, 46b of FIG. 1. Note however, unlike in graph 310 where signal 312 leads signal 314, in graph 410, signal 412 leads signal 414. Also note that, unlike in graph 320 where signal 322 leads signal 324, in graph 420, signal 424 leads signal 422.

In graph 430, a signal 432 can be an example of an alternative serial signal that can be the same or similar to output signal 52 of FIG. 1. In the illustrated example, signal 432 is a signal that can include constant output current levels. As can be seen, signal 432 includes four distinguishable constant output current levels. The distinguishable constant current levels are associated with the channel signals. More particularly, the four different current levels can be indicative of the combination of the current levels of signals 422, 424. More particularly, a first current level can be indicative of a first state (e.g., Normal operational state A) of the current levels of signals 422, 424, a second current level can be indicative of a second state (e.g., Normal operational state D) of the current levels of signals 422, 424, a third current level can be indicative of a third state (e.g., Normal operational state C) of the current levels of signals 422, 424, and a fourth current level can be indicative of a fourth state (e.g., Normal operational state B) of the current levels of signals 422, 424. The sequence of the current levels of signal 432 can be indicative a direction of rotation of the target. For example, as can be seen, the sequence of current levels A, D, C, B is produced by the leading edges of the pulses of signal 424 leading the leading edges of the pulses of signal 422. This may indicate the second direction of target rotation as described above. In addition, a rate of change or transition of the current levels (signal levels) of signal 432 can be indicative of a speed of rotation of the target.

Similar to signal 332 previously described, the constant output current levels of signal 432 allows for determining a power on state of a sensor, such as sensor 10 of FIG. 1. That is, the constant output current levels of signal 432 can be indicative of a state of the two channels (e.g., channel 1 as indicated by signal 422 and channel 2 as indicated by signal 424) of sensor 10 at any time including at a time proximate to power on of sensor 10.

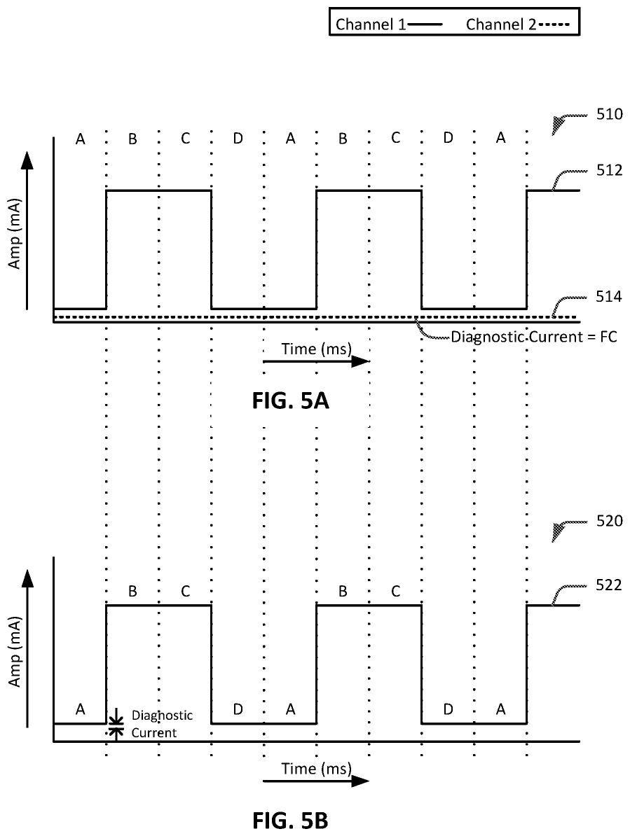

FIG. 5A illustrates an example waveform of a channel signal and a diagnostic signal. FIG. 5B illustrates an example waveform of a sensor output signal indicating a fault state based on the signals of FIG. 5A, in accordance with an embodiment of the present disclosure. As shown in FIGS. 5A and 5B, graphs 510, 520 have the same horizontal axes with scales in arbitrary units of time and vertical axes in scales of units of amps.

With reference to FIG. 5A, in graph 510, a signal 512 can be indicative of phase separated channel signal 46a of FIG. 1, and a signal 514 can be indicative of phase separated channel signal 46b of FIG. 1. Signal 512 is substantially similar to signal 322 illustrated in FIG. 3 and, thus, the previous relevant discussion with respect to features of signal 322 of FIG. 3 that are similar to signal 512 is equally applicable here. For example, similar to signal 322, signal 512 can be a two-state signal that has two distinct current levels.

As can be seen in FIG. 5A, signal 514 can have a discrete diagnostic current level. In an embodiment, the diagnostic current level can be indicative of a fault or safe state. For example, in the illustrated example, channel 2 (e.g., corresponding to left channel detector circuit 36b of FIG. 1) may be at or otherwise experiencing a fault condition and signal 514 can be indicative of such fault condition. In an embodiment, the diagnostic current level can be a relatively low level such as, for example, 1 milliamp (mA), 1.5 mA, 2 mA, or other suitable current level.

With reference to FIG. 5B, in graph 520, a signal 522 can be an example of a serial signal that can be the same or similar to output signal 52 of FIG. 1. In the illustrated example, signal 522 is a signal that can include constant output current levels. As can be seen, signal 522 includes two different output current levels that can be indicative of the combination of the current levels of signals 512, 514. In an implementation, signal 522 is indicative of the current levels as represented by the square wave of signal 512 (channel 1) riding on top of the diagnostic current level of signal 514 (channel 2).

Note that the output current levels of signal 522 can be used to determine the channel that is in a fault state and the channel that is not in a fault state (i.e., in a normal operational state). Furthermore, the constant output current levels of signal 522 allows for determining a power on state of a sensor, such as sensor 10 of FIG. 1. More particularly, as can be seen in FIG. 5B, the constant output current levels of signal 522 can be indicative not only of the channel that is in a fault state and the channel that is not in a fault state but also of a state of the channel that is not in the fault state at any time including at a time proximate to power on of sensor 10. Also, since the output current levels of signal 522 are of an operating channel (e.g., channel 1), a rate of change or transition of the current levels (signal levels) of signal 522 can be indicative of a speed of rotation of the target.

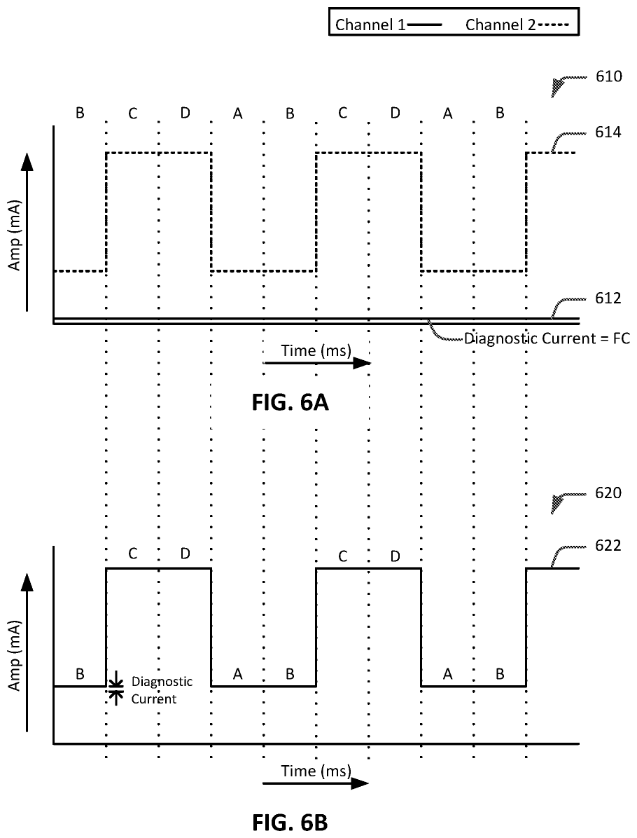

FIG. 6A illustrates an example waveform of a channel signal and a diagnostic signal. FIG. 6B illustrates an example waveform of a sensor output signal indicating a fault state based on the signals of FIG. 6A, in accordance with an embodiment of the present disclosure. As shown in FIGS. 6A and 6B, graphs 610, 620 have the same horizontal axes with scales in arbitrary units of time and vertical axes in scales of units of amps.

With reference to FIG. 6A, in graph 610, a signal 612 can be indicative of phase separated channel signal 46a of FIG. 1, and a signal 614 can be indicative of phase separated channel signal 46b of FIG. 1. Signal 614 is substantially similar to signal 324 illustrated in FIG. 3 and, thus, the previous relevant discussion with respect to features of signal 324 of FIG. 3 that are similar to signal 614 is equally applicable here. For example, similar to signal 324, signal 614 can be a two-state signal that has two distinct current levels.

As can be seen in FIG. 6A, signal 612 can have a discrete diagnostic current level. In an embodiment, the diagnostic current level can be indicative of a fault or safe state. For example, in the illustrated example, channel 1 (e.g., corresponding to right channel detector circuit 36a of FIG. 1) may be at or otherwise experiencing a fault condition and signal 612 can be indicative of such fault condition.

With reference to FIG. 6B, in graph 620, a signal 622 can be an example of a serial signal that can be the same or similar to output signal 52 of FIG. 1. In the illustrated example, signal 622 is a signal that can include constant output current levels. As can be seen, signal 622 includes two different output current levels that can be indicative of the combination of the current levels of signals 612, 614. In an implementation, signal 622 is indicative of the current levels as represented by the square wave of signal 614 (channel 2) riding on top of the diagnostic current level of signal 612 (channel 1).

Note that the output current levels of signal 622 can be used to determine the channel that is in a fault state and the channel that is not in a fault state (i.e., in a normal operational state). Furthermore, the constant output current levels of signal 622 allows for determining a power on state of a sensor, such as sensor 10 of FIG. 1. More particularly, as can be seen in FIG. 6B, the constant output current levels of signal 622 can be indicative not only of the channel that is in a fault state and the channel that is not in a fault state but also of a state of the channel that is not in the fault state at any time including at a time proximate to power on of sensor 10. Also, since the output current levels of signal 622 are of an operating channel (e.g., channel 2), a rate of change or transition of the current levels (signal levels) of signal 622 can be indicative of a speed of rotation of the target.

The following examples pertain to further embodiments, from which numerous permutations and configurations will be apparent.

Example 1 includes a magnetic field sensor including: one or more magnetic field sensing elements operable to generate a respective one or more magnetic field signals indicative of a magnetic field associated with an object; one or more channel detector circuits coupled to receive one or more of the one or more magnetic field signals, the one or more channel detector circuits configured to generate a respective one or more channel signals; and an output protocol circuit coupled to receive the one or more channel signals and configured to generate a sensor output signal comprising distinguishable constant current levels associated with the one or more channel signals.

Example 2 includes the subject matter of Example 1, wherein the one or more channel signals are phase separated channel signals.

Example 3 includes the subject matter of any of Examples 1 and 2, wherein the output sensor signal is operable to provide a power on state of at least one channel of the one or more channels.

Example 4 includes the subject matter of Example 3, wherein the power on state includes a channel fault state.

Example 5 includes the subject matter of any of Examples 1 through 4, wherein the channel signals include a first channel signal and a second channel signal, the first channel signal including a first plurality of current levels and the second channel including a second plurality of current levels, and wherein the distinguishable constant current levels of the output sensor signal are indicative of a state of the plurality of current levels of the first and second channel signals.

Example 6 includes the subject matter of Example 5, wherein the state is one of a normal operational state, first channel fault state, or a second channel fault state.

Example 7 includes the subject matter of any of Examples 1 through 6, wherein the distinguishable constant current levels include a diagnostic current level.

Example 8 includes the subject matter of any of Examples 1 through 7, wherein the sensor output signal comprises transitions between the distinguishable constant current levels indicative of a speed of rotation of the object.

Example 9 includes the subject matter of any of Examples 1 through 8, wherein the sensor output signal comprises a sequence of the distinguishable constant current levels indicative of a direction of rotation of the object.

Example 10 includes the subject matter of any of Examples 1 through 9, wherein the one or more magnetic field sensing elements includes a Hall effect element.

Example 11 includes a method to indicate a state of a magnetic field sensor, the method including: generating one or more magnetic field signals indicative of a magnetic field associated with an object; processing the one or more magnetic field signals to generate a respective one or more channel signals; and processing the respective one or more channel signals to generate a sensor output signal comprising distinguishable constant current levels associated with the one or more channel signals.

Example 12 includes the subject matter of Example 11, wherein the one or more channel signals are phase separated channel signals.

Example 13 includes the subject matter of any of Examples 11 and 12, wherein the output sensor signal is operable to provide a power on state of at least one channel of the one or more channels.

Example 14 includes the subject matter of Example 13, wherein the power on state includes a channel fault state.

Example 15 includes the subject matter of any of Examples 11 through 14, wherein the distinguishable constant current levels of the output sensor signal are indicative of a combination of a plurality of distinguishable current levels of the one or more channel signals.

Example 16 includes the subject matter of any of Examples 11 through 15, wherein the distinguishable constant current levels of the output sensor signal include a diagnostic current level indicating a fault.

Example 17 includes the subject matter of any of Examples 11 through 16, wherein the sensor output signal comprises transitions between the distinguishable constant current levels indicative of a speed of rotation of the object.

Example 18 includes the subject matter of any of Examples 11 through 17, wherein the sensor output signal comprises a sequence of the distinguishable constant current levels indicative of a direction of rotation of the object.

Example 19 includes the subject matter of any of Examples 11 through 18, wherein the one or more magnetic field sensing elements includes a Hall effect element.

Example 20 includes a magnetic field sensor including: a means for generating magnetic field signals indicative of a magnetic field associated with an object; a means for generating phase separated channel signals based on the magnetic field signals; and a means for generating a sensor output signal comprising distinguishable constant current levels associated with the channel signals.

Example 21 includes the subject matter of Example 20, wherein the output sensor signal is operable to provide a power on state of at least one channel associated with the channel signals.

Example 22 includes the subject matter of Example 21, wherein the power on state includes a channel fault state.

Example 23 includes the subject matter of any of Examples 20 through 21, wherein the distinguishable constant current levels of the output sensor signal are generated by combining distinguishable current levels of the channel signals.

Example 24 includes the subject matter of any of Examples 20 through 22, wherein the distinguishable constant current levels of the output sensor signal include a diagnostic current level indicating a fault.

Example 25 includes the subject matter of any of Examples 20 through 24, wherein the sensor output signal comprises transitions between the distinguishable constant current levels indicative of a speed of rotation of the object.

Example 26 includes the subject matter of any of Examples 20 through 25, wherein the sensor output signal comprises a sequence of the distinguishable constant current levels indicative of a direction of rotation of the object.

Terms used in the present disclosure and in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, such recitation should be interpreted to mean at least the recited number (e.g., the bare recitation of “two widgets,” without other modifiers, means at least two widgets, or two or more widgets). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

All examples and conditional language recited in the present disclosure are intended for pedagogical examples to aid the reader in understanding the present disclosure, and are to be construed as being without limitation to such specifically recited examples and conditions. Although example embodiments of the present disclosure have been described in detail, various changes, substitutions, and alterations could be made hereto without departing from the spirit and scope of the present disclosure. Accordingly, it is intended that the scope of the present disclosure be limited not by this detailed description, but rather by the claims appended hereto.

What is claimed is:

1. A magnetic field sensor, comprising:
one or more magnetic field sensing elements operable to generate a respective one or more magnetic field signals indicative of a magnetic field associated with an object;
one or more channel detector circuits coupled to receive one or more of the one or more magnetic field signals, the one or more channel detector circuits configured to generate a respective one or more channel signals; and
an output protocol circuit coupled to receive the one or more channel signals and configured to generate a sensor output signal comprising distinguishable constant current levels associated with the one or more channel signals.

2. The magnetic field sensor of claim 1, wherein the one or more channel signals are phase separated channel signals.

3. The magnetic field sensor of claim 1, wherein the output sensor signal is operable to provide a power on state of at least one channel of the one or more channels.

4. The magnetic field sensor of claim 3, wherein the power on state includes a channel fault state.

5. The magnetic field sensor of claim 1, wherein the channel signals include a first channel signal and a second channel signal, the first channel signal including a first plurality of current levels and the second channel including a second plurality of current levels, and wherein the distinguishable constant current levels of the output sensor signal are indicative of a state of the plurality of current levels of the first and second channel signals.

6. The magnetic field sensor of claim 5, wherein the state is one of a normal operational state, first channel fault state, or a second channel fault state.

7. The magnetic field sensor of claim 1, wherein the distinguishable constant current levels include a diagnostic current level.

8. The magnetic field sensor of claim 1, wherein the sensor output signal comprises transitions between the distinguishable constant current levels indicative of a speed of rotation of the object.

9. The magnetic field sensor of claim 1, wherein the sensor output signal comprises a sequence of the distinguishable constant current levels indicative of a direction of rotation of the object.

10. The magnetic field sensor of claim 1, wherein the one or more magnetic field sensing elements includes a Hall effect element.

11. A method to indicate a state of a magnetic field sensor, the method comprising:
generating one or more magnetic field signals indicative of a magnetic field associated with an object;
processing the one or more magnetic field signals to generate a respective one or more channel signals; and
processing the respective one or more channel signals to generate a sensor output signal comprising distinguishable constant current levels associated with the one or more channel signals.

12. The method of claim 11, wherein the one or more channel signals are phase separated channel signals.

13. The method of claim 11, wherein the output sensor signal is operable to provide a power on state of at least one channel of the one or more channels.

14. The method of claim 11, wherein the distinguishable constant current levels of the output sensor signal are indicative of a combination of a plurality of distinguishable current levels of the one or more channel signals.

15. The method of claim 11, wherein the distinguishable constant current levels of the output sensor signal include a diagnostic current level indicating a fault.

16. The method of claim 11, wherein the sensor output signal comprises transitions between the distinguishable constant current levels indicative of a speed of rotation of the object.

17. The method of claim 11, wherein the sensor output signal comprises a sequence of the distinguishable constant current levels indicative of a direction of rotation of the object.

18. A magnetic field sensor, comprising:
means for generating a plurality of magnetic field signals indicative of a magnetic field associated with an object;
means for generating a plurality of phase separated channel signals based on the plurality of magnetic field signals; and
means for generating a sensor output signal comprising distinguishable constant current levels associated with the plurality of channel signals.

19. The magnetic field sensor of claim 18, wherein the distinguishable constant current levels of the output sensor signal are generated by combining a plurality of distinguishable current levels of the plurality of channel signals.

20. The magnetic field sensor of claim 18, wherein the distinguishable constant current levels of the output sensor signal include a diagnostic current level indicating a fault.
